(19) United States
(12) Patent Application Publication
(10) Pub. No.: US 2006/0229216 A1
(43) Pub. Date: Oct. 12, 2006

(54) Method of improving the stability or compatibility of a detergent

(76) Inventors: Peter John Dowding, Wantage (GB); Christopher John Adams, Tilehurst (GB)

Correspondence Address: INFINEUM USA L.P., P.O. BOX 710, LINDEN, NJ, 07036, US

(21) Appl. No.: 11/395,708

(22) Filed: Mar. 31, 2006

(30) Foreign Application Priority Data
Apr. 6, 2005 (EP) 05252141.6

(51) Int. Cl. A01N 29/04

(52) U.S. Cl. 508/388

(57) ABSTRACT

A method of improving the stability of a detergent or of improving the compatibility of a detergent with another additive in a lubricating oil composition. The method includes the step of reacting the detergent with a water-soluble α,β-unsaturated carbonyl compound.

The present invention relates to a method of improving the stability of a detergent in a lubricating oil composition, or a method of improving the compatibility of a detergent with other additives in a lubricating oil composition, such as friction modifiers, other detergents, metal rust inhibitors, viscosity index improvers, corrosion inhibitors, oxidation inhibitors and anti-wear agents. In particular, the invention relates to a method of improving the compatibility of a detergent with friction modifiers or other detergents present in a lubricating oil composition.

Currently there is a drive in terms of fuel economy for gasoline and diesel engines which has resulted in increased levels of organic friction modifiers being used in lubricating oil compositions; unfortunately, there are compatibility issues between the friction modifiers and detergents, such as overbased calcium sulphonates. The present invention is therefore concerned with improving the compatibility between friction modifiers and detergents in lubricating oil compositions.

The present invention is also concerned with the problem of improving the compatibility between different types of detergents. For example, overbased calcium sulphonates and overbased calcium salicylates are generally not used together in lubricating oil compositions due to poor compatibility.

Finally, the present invention is concerned with improving the stability of detergents in lubricating oil compositions.

In accordance with the present invention, there is provided a method of improving the stability of a detergent in a lubricating oil composition or a method of improving the compatibility of a detergent with another additive in a lubricating oil composition; the method including the step of reacting the detergent with a water-soluble α,β-unsaturated carbonyl compound.

The inventors have found that the modified detergent exhibits improved compatibility with other additives found in lubricating oil compositions. The inventors have also found that the modified detergent exhibits improved stability in lubricating oil compositions.

The detergent is preferably an overbased oil soluble detergent comprising an alkali- or alkaline earth metal hydrocarbyl phenate, carboxylate or sulphonate.

The detergent is preferably a hybrid/complex detergent prepared from at least two of the following surfactants: phenol, sulphonic acid, carboxylic acid or salicylic acid. The mixture of at least two surfactants is usually overbased with carbon dioxide in the presence of at least one solvent and calcium hydroxide. The detergent may be selected from: the hybrid/complex detergents disclosed in EP 902 827B; the carboxylated detergent-dispersants disclosed in EP 1 452 581A; the metal phenate/stearates disclosed in EP 761 648; or the detergents disclosed in EP 271 262 or EP 273 588.

The water-soluble α,β-unsaturated carbonyl compound is preferably selected from maleic anhydride, itaconic anhydride, citriconic anhydride, alkyl maleic anhydride, cycloalkyl maleic anhydride, acrylic acid and methacrylic acid. The water-soluble α,β-unsaturated carbonyl compound is preferably maleic anhydride.

Metal-containing or ash-forming detergents function as both detergents to reduce or remove deposits and as acid neutralizers or rust inhibitors, thereby reducing wear and corrosion and extending engine life. Detergents generally comprise a polar head with a long hydrophobic tail. The polar head comprises a metal salt of an acidic organic compound. The salts may contain a substantially stoichiometric amount of the metal in which case they are usually described as normal or neutral salts, and would typically have a total base number or TBN (as can be measured by ASTM D2896) of from 0 to 80. A large amount of a metal base may be incorporated by reacting excess metal compound (e.g., an oxide or hydroxide) with an acidic gas (e.g., carbon dioxide). The resulting overbased detergent comprises neutralized detergent as the outer layer of a metal base (e.g. carbonate) micelle. Such overbased detergents may have a TBN of 150 or greater, and typically will have a TBN of from 250 to 450 or more.

Detergents that may be used include oil-soluble neutral and overbased sulphonates, phenates, sulphurized phenates, thiophosphonates, salicylates, and naphthenates and other oil-soluble carboxylates of a metal, particularly the alkali or alkaline earth metals, e.g., barium, sodium, potassium, lithium, calcium, and magnesium. The most commonly used metals are calcium and magnesium, which may both be present in detergents used in a lubricant, and mixtures of calcium and/or magnesium with sodium. Particularly convenient metal detergents are neutral and overbased calcium sulphonates having a TBN of from 20 to 450, neutral and overbased calcium phenates and sulphurized phenates having a TBN of from 50 to 450 and neutral and overbased magnesium or calcium salicylates having a TBN of from 20 to 450. Combinations of detergents, whether overbased or neutral or both, may be used.

Sulphonates may be prepared from sulphonic acids which are typically obtained by the sulphonation of alkyl substituted aromatic hydrocarbons such as those obtained from the fractionation of petroleum or by the alkylation of aromatic hydrocarbons. Examples include those obtained by alkylating benzene, toluene, xylene, naphthalene, diphenyl or their halogen derivatives such as chlorobenzene, chlorotoluene and chloronaphthalene. The alkylation may be carried out in the presence of a catalyst with alkylating agents, such as olefins, having from about 3 to more than 70 carbon atoms. The alkaryl sulphonates usually contain from about 9 to about 80 or more carbon atoms, preferably from about 16 to about 60 carbon atoms per alkyl substituted aromatic moiety.

The oil soluble sulphonates or alkaryl sulphonic acids may be neutralized with oxides, hydroxides, alkoxides, carbonates, carboxylates, sulphides, hydrosulphides, nitrates, borates and ethers of the metal. The amount of metal compound is chosen having regard to the desired TBN of the final product but typically ranges from about 100 to 220 wt. % (preferably at least 125 wt. %) of that stoichiometrically required.

Metal salts of phenols and sulphurized phenols are prepared by reaction with an appropriate metal compound such as an oxide or hydroxide and neutral or overbased products may be obtained by methods well known in the art. Sulphurized phenols may be prepared by reacting a phenol with sulphur or a sulphur-containing compound such as hydrogen sulphide, sulphur monohalide or sulphur dihalide, to form products which are generally mixtures of compounds in which 2 or more phenols are bridged by sulphur containing bridges.

Carboxylate detergents, e.g., salicylates, can be prepared by reacting an aromatic carboxylic acid with an appropriate metal compound such as an oxide or hydroxide and neutral or overbased products may be obtained by methods well known in the art. The aromatic moiety of the aromatic carboxylic acid can contain heteroatoms, such as nitrogen and oxygen. Preferably, the moiety contains only carbon atoms; more preferably the moiety contains six or more carbon atoms; for example benzene is a preferred moiety. The aromatic carboxylic acid may contain one or more aromatic moieties, such as one or more benzene rings, either fused or connected via alkylene bridges. The carboxylic moiety may be attached directly or indirectly to the aromatic moiety. Preferably the carboxylic acid group is attached directly to a carbon atom on the aromatic moiety, such as a carbon atom on the benzene ring. More preferably, the aromatic moiety also contains a second functional group, such as a hydroxy group or a sulphonate group, which can be attached directly or indirectly to a carbon atom on the aromatic moiety.

Preferred examples of aromatic carboxylic acids are salicylic acids and sulphurized derivatives thereof, such as hydrocarbyl substituted salicylic acid and derivatives thereof. Processes for sulphurizing, for example a hydrocarbyl-substituted salicylic acid, are known to those skilled in the art. Salicylic acids are typically prepared by carboxylation, for example, by the Kolbe-Schmitt process, of phenoxides, and in that case, will generally be obtained, normally in a diluent, in admixture with uncarboxylated phenol.

Preferred substituents in oil-soluble salicylic acids are alkyl substituents. In alkyl-substituted salicylic acids, the alkyl groups advantageously contain 5 to 100, preferably 9 to 30, especially 14 to 20, carbon atoms. Where there is more than one alkyl group, the average number of carbon atoms in all of the alkyl groups is preferably at least 9 to ensure adequate oil solubility.

Detergents useful in the practice of the present invention may also be “hybrid” detergents formed with mixed surfactant systems including at least two of the following surfactants: phenol, salicylic acid, sulphonic acid, carboxylic acid or derivatives thereof. The hybrid detergents are preferably: phenate/salicylates, sulphonate/phenates, sulphonate/salicylates or sulphonates/phenates/salicylates, as described, for example, in EP 902 827B. The mixed surfactant systems are preferably overbased using carbon dioxide in the presence of calcium hydroxide and oil at a temperature of less than 100° C., preferably at a temperature of 15-60° C. The reaction preferably includes at least one heat-soaking step. The reaction is preferably carried out without the use of dihydric alcohols, inorganic halides or ammonium salt catalysts so that the detergents are free from inorganic halides, ammonium salt catalysts or groups derived therefrom. The hybrid detergents preferably have a TBN (as measured by ASTM D2896) of at least 250, preferably of at least 300.

The hybrid detergents may also be carboxylated detergent-dispersants as described, for example, in EP 1 452 581 A; metal phenate/stearate detergents as described in EP 761 648; or the detergents as described in EP 271 262 or EP 273 588.

The detergent may also be a saligenin detergent (as disclosed in WO 2001/074751) derived from

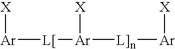

where Ar is an aromatic moiety with or without at least one additional substituent; L is a divalent linking group which may be the same or different in each repeating unit; X is —OH, —COOH or sulphonic acid, or an ester or amide or salt thereof; and n=0-10. X may be a metal salt such as an alkali or alkaline earth metal salt (e.g. calcium or magnesium salt). The aromatic moiety may include up to 3 substituents selected from hydrocarbyl, hetero-substituted hydrocarbyl, —NR¹R², —OR¹, —CR¹R²OR³, —CHO, —COOH or an amide or salt thereof, wherein R¹, R² and R³ are independently hydrogen, hydrocarbyl or hetero-substituted hydrocarbyl. The detergent may be sulphur-free. L may be (CHR)ₘ, wherein m is an integer of at least 1 and R is a hydrogen or hydrocarbyl. L may be a nitrogen-containing moiety.

It is not unusual to add a detergent or other additive to a lubricating oil, or additive concentrate, in a diluent such that only a portion of the added weight represents an active ingredient (A.I.). For example, the detergent may be added together with an equal weight of diluent in which case the “additive” is 50% A.I. detergent.

To provide the modified detergent, a metal-containing, or ash-forming, detergent is reacted with a water-soluble α,β-unsaturated carbonyl compound. Examples of suitable water-soluble α,β-unsaturated carbonyl compounds include maleic acid and anhydride, alkyl and cycloalkyl maleic acid, itaconic acid and anhydride, acrylic acid and anhydride, methacrylic acid and anhydride and citriconic acid and anhydride. Preferred water-soluble α,β-unsaturated carbonyl compounds include maleic anhydride, itaconic anhydride, acrylic acid and methacrylic acid, most preferably maleic anhydride. To provide the desired properties, the detergent is reacted with from about 0.5 to about 10, preferably from about 1 to about 6, more preferably from about 2 to about 5 wt. %, e.g., 2 to 4 wt. %, of the water-soluble α,β-unsaturated carbonyl compound, based on the weight of detergent. The reaction can be carried out at temperatures of from about 30° C. to about 200° C., preferably from about 60° C. to about 150° C., more preferably from about 80° C. to about 120° C., for about 0.5 hours to about 8 hours. The reaction can be conducted neat, or using a conventional solvent media, such as a mineral lubricating oil solvent so that the final product is in a convenient lubricating oil solution that is entirely compatible with a lubricating oil base stock and these generally include lubricating oils having a kinematic viscosity (ASTM D-445) of from about 2 to about 40, preferably from about 5 to 20 centistokes at 99° C. Particularly preferred solvent media include primarily paraffinic mineral oils, such as Solvent Neutral 150 (SN150).

The friction modifiers include glyceryl monoesters of higher fatty acids, for example, glyceryl mono-oleate; esters of long chain polycarboxylic acids with diols, for example, the butane diol ester of a dimerized unsaturated fatty acid; oxazoline compounds; and alkoxylated alkyl-substituted mono-amines, diamines and alkyl ether amines, for example, ethoxylated tallow amine and ethoxylated tallow ether amine.

Other known friction modifiers comprise oil-soluble organo-molybdenum compounds. Such organo-molybdenum friction modifiers also provide antioxidant and antiwear credits to a lubricating oil composition. As an example of such oil-soluble organo-molybdenum compounds, there may be mentioned the dithiocarbamates, dithiophosphates, dithiophosphinates, xanthates, thioxanthates, sulphides, and the like, and mixtures thereof. Particularly preferred are molybdenum dithiocarbamates, dialkyldithiophosphates, alkyl xanthates and alkylthioxanthates.

Additionally, the molybdenum compound may be an acidic molybdenum compound. These compounds will react with a basic nitrogen compound as measured by ASTM test D-664 or D-2896 titration procedure and are typically hexavalent. Included are molybdic acid, ammonium molybdate, sodium molybdate, potassium molybdate, and other alkaline metal molybdates and other molybdenum salts, e.g., hydrogen sodium molybdate, MoOCl₄, MoO₂Br₂, Mo₂O₃Cl₆, molybdenum trioxide or similar acidic molybdenum compounds.

The molybdenum compounds may be of the formula
Mo(ROCS₂)₄ and
Mo(RSCS₂)₄
wherein R is an organo group selected from the group consisting of alkyl, aryl, aralkyl and alkoxyalkyl, generally of from 1 to 30 carbon atoms, and preferably 2 to 12 carbon atoms and most preferably alkyl of 2 to 12 carbon atoms. Especially preferred are the dialkyldithiocarbamates of molybdenum.

Another group of organo-molybdenum compounds are trinuclear molybdenum compounds, especially those of the formula Mo₃SₖLₙQ_{z} and mixtures thereof wherein the L are independently selected ligands having organo groups with a sufficient number of carbon atoms to render the compound soluble or dispersible in the oil, n is from 1 to 4, k varies from 4 through 7, Q is selected from the group of neutral electron donating compounds such as water, amines, alcohols, phosphines, and ethers, and z ranges from 0 to 5 and includes non-stoichiometric values. At least 21 total carbon atoms should be present among all the ligands' organo groups, such as at least 25, at least 30, or at least 35 carbon atoms.

The ligands are independently selected from the group of 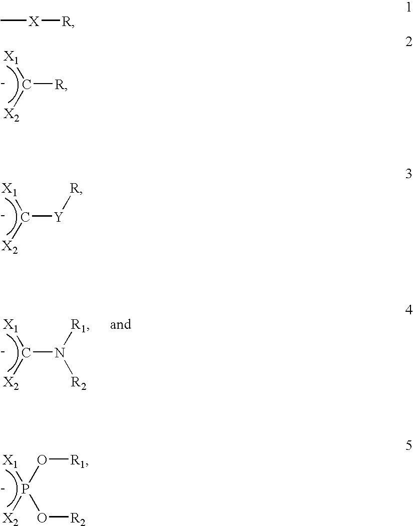
and mixtures thereof, wherein X, X₁, X₂, and Y are independently selected from the group of oxygen and sulphur, and wherein R₁, R₂, and R are independently selected from hydrogen and organo groups that may be the same or different. Preferably, the organo groups are hydrocarbyl groups such as alkyl (e.g., in which the carbon atom attached to the remainder of the ligand is primary or secondary), aryl, substituted aryl and ether groups. More preferably, each ligand has the same hydrocarbyl group.

The term “hydrocarbyl” denotes a substituent having carbon atoms directly attached to the remainder of the ligand and is predominantly hydrocarbyl in character within the context of this invention. Such substituents include the following:

1. Hydrocarbon substituents, that is, aliphatic (for example alkyl or alkenyl), alicyclic (for example cycloalkyl or cycloalkenyl) substituents, aromatic-, aliphatic- and alicyclic-substituted aromatic nuclei and the like, as well as cyclic substituents wherein the ring is completed through another portion of the ligand (that is, any two indicated substituents may together form an alicyclic group).

2. Substituted hydrocarbon substituents, that is, those containing non-hydrocarbon groups which, in the context of this invention, do not alter the predominantly hydrocarbyl character of the substituent. Those skilled in the art will be aware of suitable groups (e.g., halo, especially chloro and fluoro, amino, alkoxyl, mercapto, alkylmercapto, nitro, nitroso, sulphoxy, etc.).

3. Hetero substituents, that is, substituents which, while predominantly hydrocarbon in character within the context of this invention, contain atoms other than carbon present in a chain or ring otherwise composed of carbon atoms.

Importantly, the organo groups of the ligands have a sufficient number of carbon atoms to render the compound soluble or dispersible in the oil. For example, the number of carbon atoms in each group will generally range between about 1 to about 100, preferably from about 1 to about 30, and more preferably between about 4 to about 20. Preferred ligands include dialkyldithiophosphate, alkylxanthate, and dialkyldithiocarbamate, and of these dialkyldithiocarbamate is more preferred. Organic ligands containing two or more of the above functionalities are also capable of serving as ligands and binding to one or more of the cores. Those skilled in the art will realize that formation of the compounds requires selection of ligands having the appropriate charge to balance the core's charge.

Compounds having the formula Mo₃SₖLₙQ_{z} have cationic cores surrounded by anionic ligands and are represented by structures such as 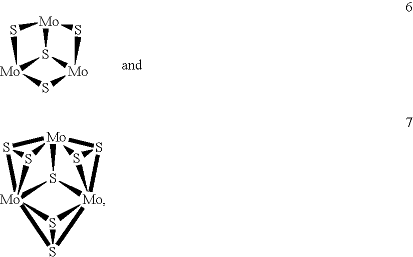
and have net charges of +4. Consequently, in order to solubilize these cores the total charge among all the ligands must be −4. Four monoanionic ligands are preferred. Without wishing to be bound by any theory, it is believed that two or more trinuclear cores may be bound or interconnected by means of one or more ligands and the ligands may be multidentate. This includes the case of a multidentate ligand having multiple connections to a single core. It is believed that oxygen and/or selenium may be substituted for sulphur in the core(s).

Oil-soluble or dispersible trinuclear molybdenum compounds can be prepared by reacting in the appropriate liquid(s)/solvent(s) a molybdenum source such as (NH₄)₂Mo₃S₁₃.n(H₂O), where n varies between 0 and 2 and includes non-stoichiometric values, with a suitable ligand source such as a tetralkylthiuram disulphide. Other oil-soluble or dispersible trinuclear molybdenum compounds can be formed during a reaction in the appropriate solvent(s) of a molybdenum source such as of (NH₄)₂Mo₃S₁₃.n(H₂O), a ligand source such as tetralkylthiuram disulphide, dialkyldithiocarbamate, or dialkyldithiophosphate, and a sulphur abstracting agent such cyanide ions, sulphite ions, or substituted phosphines. Alternatively, a trinuclear molybdenum-sulphur halide salt such as [M′]₂[Mo₃S₇A₆], where M′ is a counter ion, and A is a halogen such as Cl, Br, or I, may be reacted with a ligand source such as a dialkyldithiocarbamate or dialkyldithiophosphate in the appropriate liquid(s)/solvent(s) to form an oil-soluble or dispersible trinuclear molybdenum compound. The appropriate liquid/solvent may be, for example, aqueous or organic.

A compound's oil solubility or dispersibility may be influenced by the number of carbon atoms in the ligand's organo groups. At least 21 total carbon atoms should be present among all the ligand's organo groups. Preferably, the ligand source chosen has a sufficient number of carbon atoms in its organo groups to render the compound soluble or dispersible in the lubricating composition.

The terms “oil-soluble” or “dispersible” used herein do not necessarily indicate that the compounds or additives are soluble, dissolvable, miscible, or capable of being suspended in the oil in all proportions. These do mean, however, that they are, for instance, soluble or stably dispersible in oil to an extent sufficient to exert their intended effect in the environment in which the oil is employed. Moreover, the additional incorporation of other additives may also permit incorporation of higher levels of a particular additive, if desired.

The molybdenum compound is preferably an organo-molybdenum compound. Moreover, the molybdenum compound is preferably selected from the group consisting of a molybdenum dithiocarbamate (MoDTC), molybdenum dithiophosphate, molybdenum dithiophosphinate, molybdenum xanthate, molybdenum thioxanthate, molybdenum sulphide and mixtures thereof. Most preferably, the molybdenum compound is present as molybdenum dithiocarbamate. The molybdenum compound may also be a trinuclear molybdenum compound.

The lubricating oils in the lubricating oil compositions may range in viscosity from light distillate mineral oils to heavy lubricating oils such as gasoline engine oils, mineral lubricating oils and heavy duty diesel oils. Generally, the viscosity of the oil ranges from about 2 mm²/sec (centistokes) to about 40 mm²/sec, especially from about 4 mm²/sec to about 20 mm²/sec, as measured at 100° C.

Natural oils include animal oils and vegetable oils (e.g., castor oil, lard oil); liquid petroleum oils and hydrorefined, solvent-treated or acid-treated mineral oils of the paraffinic, naphthenic and mixed paraffinic-naphthenic types. Oils of lubricating viscosity derived from coal or shale also serve as useful base oils.

Synthetic lubricating oils include hydrocarbon oils and halo-substituted hydrocarbon oils such as polymerized and interpolymerized olefins (e.g., polybutylenes, polypropylenes, propylene-isobutylene copolymers, chlorinated polybutylenes, poly(1-hexenes), poly(1-octenes), poly(1-decenes)); alkylbenzenes (e.g., dodecylbenzenes, tetradecylbenzenes, dinonylbenzenes, di(2-ethylhexyl)benzenes); polyphenyls (e.g., biphenyls, terphenyls, alkylated polyphenols); and alkylated diphenyl ethers and alkylated diphenyl sulphides and derivative, analogs and homologs thereof.

Alkylene oxide polymers and interpolymers and derivatives thereof where the terminal hydroxyl groups have been modified by esterification, etherification, etc., constitute another class of known synthetic lubricating oils. These are exemplified by polyoxyalkylene polymers prepared by polymerization of ethylene oxide or propylene oxide, and the alkyl and aryl ethers of polyoxyalkylene polymers (e.g., methyl-polyiso-propylene glycol ether having a molecular weight of 1000 or diphenyl ether of poly-ethylene glycol having a molecular weight of 1000 to 1500); and mono- and polycarboxylic esters thereof, for example, the acetic acid esters, mixed C₃-C₈ fatty acid esters and C₁₃ Oxo acid diester of tetraethylene glycol.

Another suitable class of synthetic lubricating oils comprises the esters of dicarboxylic acids (e.g., phthalic acid, succinic acid, alkyl succinic acids and alkenyl succinic acids, maleic acid, azelaic acid, suberic acid, sebasic acid, fumaric acid, adipic acid, linoleic acid dimer, malonic acid, alkylmalonic acids, alkenyl malonic acids) with a variety of alcohols (e.g., butyl alcohol, hexyl alcohol, dodecyl alcohol, 2-ethylhexyl alcohol, ethylene glycol, diethylene glycol monoether, propylene glycol). Specific examples of such esters includes dibutyl adipate, di(2-ethylhexyl) sebacate, di-n-hexyl fumarate, dioctyl sebacate, diisooctyl azelate, diisodecyl azelate, dioctyl phthalate, didecyl phthalate, dieicosyl sebacate, the 2-ethylhexyl diester of linoleic acid dimer, and the complex ester formed by reacting one mole of sebacic acid with two moles of tetraethylene glycol and two moles of 2-ethylhexanoic acid.

Esters useful as synthetic oils also include those made from C₅ to C₁₂ monocarboxylic acids and polyols and polyol esters such as neopentyl glycol, trimethylolpropane, pentaerythritol, dipentaerythritol and tripentaerythritol.

Silicon-based oils such as the polyalkyl-, polyaryl-, polyalkoxy- or polyaryloxysilicone oils and silicate oils comprise another useful class of synthetic lubricants; such oils include tetraethyl silicate, tetraisopropyl silicate, tetra-(2-ethylhexyl)silicate, tetra-(4-methyl-2-ethylhexyl)silicate, tetra-(p-tert-butyl-phenyl) silicate, hexa-(4-methyl-2-ethylhexyl)disiloxane, poly(methyl)siloxanes and poly(methylphenyl)siloxanes. Other synthetic lubricating oils include liquid esters of phosphorous-containing acids (e.g., tricresyl phosphate, trioctyl phosphate, diethyl ester of decylphosphonic acid) and polymeric tetrahydrofurans.

Unrefined, refined and re-refined oils can be used in lubricants of the present invention. Unrefined oils are those obtained directly from a natural or synthetic source without further purification treatment. For example, a shale oil obtained directly from retorting operations; petroleum oil obtained directly from distillation; or ester oil obtained directly from an esterification and used without further treatment would be an unrefined oil. Refined oils are similar to unrefined oils except that the oil is further treated in one or more purification steps to improve one or more properties. Many such purification techniques, such as distillation, solvent extraction, acid or base extraction, filtration and percolation are known to those skilled in the art. Re-refined oils are obtained by processes similar to those used to provide refined oils but begin with oil that has already been used in service. Such re-refined oils are also known as reclaimed or reprocessed oils and are often subjected to additionally processing using techniques for removing spent additives and oil breakdown products.

The oil of lubricating viscosity may comprise a Group I, Group II, Group III, Group IV or Group V base stocks or base oil blends of the aforementioned base stocks. Preferably, the oil of lubricating viscosity is a Group III, Group IV or Group V base stock, or a mixture thereof provided that the volatility of the oil or oil blend, as measured by the NOACK test (ASTM D5880), is less than or equal to 13.5%, preferably less than or equal to 12%, more preferably less than or equal to 10%, most preferably less than or equal to 8%; and a viscosity index (VI) of at least 120, preferably at least 125, most preferably from about 130 to 140.

Definitions for the base stocks and base oils in this invention are the same as those found in the American Petroleum Institute (API) publication “Engine Oil Licensing and Certification System”, Industry Services Department, Fourteenth Edition, December 1996, Addendum 1, December 1998. Said publication categorizes base stocks as follows:
a) Group I base stocks contain less than 90 percent saturates and/or greater than 0.03 percent sulphur and have a viscosity index greater than or equal to 80 and less than 120 using the test methods specified in Table E-1.
b) Group II base stocks contain greater than or equal to 90 percent saturates and less than or equal to 0.03 percent sulphur and have a viscosity index greater than or equal to 80 and less than 120 using the test methods specified in Table E-1.
c) Group III base stocks contain greater than or equal to 90 percent saturates and less than or equal to 0.03 percent sulphur and have a viscosity index greater than or equal to 120 using the test methods specified in Table E-1.
d) Group IV base stocks are polyalphaolefins (PAO).

e) Group V base stocks include all other base stocks not included in Group I, II, III, or IV.

Analytical Methods for Base Stock

| Property | Test Method |
|---|---|
| Saturates | ASTM D 2007 |
| Viscosity Index | ASTM D 2270 |
| Sulphur | ASTM D 2622 |
| | ASTM D 4294 |
| | ASTM D 4927 |
| | ASTM D 3120 |

The modified detergent of the present invention can be incorporated into the lubricating oil in any convenient way. Thus, the detergent of the invention can be added directly to the oil by dispersing or dissolving the same in the oil at the desired level of concentrations. Such blending into the lubricating oil can occur at room temperature or elevated temperatures. Alternatively, the modified detergents of the invention can be introduced into the lubricating oil composition by blending the modified detergent with a suitable oil-soluble solvent and base oil to form a concentrate, and then blending the concentrate with a lubricating oil basestock to obtain the final formulation. Such concentrates will typically contain (on an active ingredient (A.I.) basis from about 10 to about 35 wt. %, and preferably from about 20 to about 30 wt. %, of the inventive detergent, and typically from about 40 to 80 wt. %, preferably from about 50 to 70 wt. %, base oil, based on the concentrate weight.

The modified detergents of the present invention may be neutral or overbased. Preferably, the modified detergents of the invention are overbased to provide a TBN of from about 70 to 500, preferably from about 100 to 400, more preferably from about 150 to about 400, e.g., 250 to 350.

The modified detergent can be used in conventional amounts. To provide sufficient detergency and rust inhibiting characteristics, the fully formulated lubricating oil composition should contain from about 0.1 to about 15 wt. %, preferably from about 0.3 to about 8 wt. %, most preferably from about 0.5 to about 5 wt. %, e.g., 1 to 3 wt. % (based on A.I.) of detergent. Detergency and rust inhibiting properties can be provided solely by use of the modified detergent of the present invention. Alternatively, a combination of a modified detergent, and an additional amount of an unmodified detergent can be used.

The modified detergent is preferably present in the lubricating oil composition in an amount providing from about 0.01 to about 1, preferably from about 0.02 to about 0.5, more preferably from about 0.03 to about 0.3, e.g., 0.05 to 0.2 moles of detergent α,β-unsaturated carbonyl moiety per mole of dispersant nitrogen.

Examples of other additives found in lubricating oil compositions are metal rust inhibitors, viscosity index improvers, corrosion inhibitors, oxidation inhibitors, anti-foaming agents, anti-wear agents and pour point depressants. Some are discussed in further detail below.

Dihydrocarbyl dithiophosphate metal salts are frequently used as antiwear and antioxidant agents. The metal may be an alkali or alkaline earth metal, or aluminum, lead, tin, molybdenum, manganese, nickel or copper. The zinc salts are most commonly used in lubricating oils in amounts of 0.1 to 10, preferably 0.2 to 2 wt. %, based upon the total weight of the lubricating oil composition. They may be prepared in accordance with known techniques by first forming a dihydrocarbyl dithiophosphoric acid (DDPA), usually by reaction of one or more alcohol or a phenol with P₂S₅ and then neutralizing the formed DDPA with a zinc compound. For example, a dithiophosphoric acid may be made by reacting mixtures of primary and secondary alcohols. Alternatively, multiple dithiophosphoric acids can be prepared where the hydrocarbyl groups on one are entirely secondary in character and the hydrocarbyl groups on the others are entirely primary in character. To make the zinc salt, any basic or neutral zinc compound could be used but the oxides, hydroxides and carbonates are most generally employed. Commercial additives frequently contain an excess of zinc due to the use of an excess of the basic zinc compound in the neutralization reaction.

The preferred zinc dihydrocarbyl dithiophosphates are oil soluble salts of dihydrocarbyl dithiophosphoric acids and may be represented by the following formula: 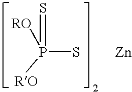
wherein R and R′ may be the same or different hydrocarbyl radicals containing from 1 to 18, preferably 2 to 12, carbon atoms and including radicals such as alkyl, alkenyl, aryl, arylalkyl, alkaryl and cycloaliphatic radicals. Particularly preferred as R and R′ groups are alkyl groups of 2 to 8 carbon atoms. Thus, the radicals may, for example, be ethyl, n-propyl, i-propyl, n-butyl, i-butyl, sec-butyl, amyl, n-hexyl, i-hexyl, n-octyl, decyl, dodecyl, octadecyl, 2-ethylhexyl, phenyl, butylphenyl, cyclohexyl, methylcyclopentyl, propenyl, butenyl. In order to obtain oil solubility, the total number of carbon atoms (i.e. R and R′) in the dithiophosphoric acid will generally be about 5 or greater. The zinc dihydrocarbyl dithiophosphate can therefore comprise zinc dialkyl dithiophosphates. The present invention may be particularly useful when used with lubricant compositions containing phosphorus levels of from about 0.02 to about 0.12 wt. %, preferably from about 0.03 to about 0.10 wt. %. More preferably, the phosphorous level of the lubricating oil composition will be less than about 0.08 wt. %, such as from about 0.05 to about 0.08 wt. %.

Oxidation inhibitors or antioxidants reduce the tendency of mineral oils to deteriorate in service. Oxidative deterioration can be evidenced by sludge in the lubricant, varnish-like deposits on the metal surfaces, and by viscosity growth. Such oxidation inhibitors include hindered phenols, alkaline earth metal salts of alkylphenolthioesters having preferably C₅ to C₁₂ alkyl side chains, alkylphenol sulphides, oil soluble phenates and sulphurized phenates, phosphosulphurized or sulphurized hydrocarbons or esters, phosphorous esters, metal thiocarbamates, oil soluble copper compounds as described in U.S. Pat. No. 4,867,890, and molybdenum-containing compounds.

Aromatic amines having at least two aromatic groups attached directly to the nitrogen constitute another class of compounds that is frequently used for antioxidancy. They are preferably used in only small amounts, i.e., up to 0.4 wt. %, or more preferably avoided altogether other than such amount as may result as an impurity from another component of the composition.

Typical oil soluble aromatic amines having at least two aromatic groups attached directly to one amine nitrogen contain from 6 to 16 carbon atoms. The amines may contain more than two aromatic groups. Compounds having a total of at least three aromatic groups in which two aromatic groups are linked by a covalent bond or by an atom or group (e.g., an oxygen or sulphur atom, or a —CO—, —SO₂— or alkylene group) and two are directly attached to one amine nitrogen also considered aromatic amines having at least two aromatic groups attached directly to the nitrogen. The aromatic rings are typically substituted by one or more substituents selected from alkyl, cycloalkyl, alkoxy, aryloxy, acyl, acylamino, hydroxy, and nitro groups. The amount of any such oil-soluble aromatic amines having at least two aromatic groups attached directly to one amine nitrogen should preferably not exceed 0.4 wt. % active ingredient.

Representative examples of suitable viscosity modifiers are polyisobutylene, copolymers of ethylene and propylene, polymethacrylates, methacrylate copolymers, copolymers of an unsaturated dicarboxylic acid and a vinyl compound, interpolymers of styrene and acrylic esters, and partially hydrogenated copolymers of styrene/isoprene, styrene/butadiene, and isoprene/butadiene, as well as the partially hydrogenated homopolymers of butadiene and isoprene.

A viscosity index improver dispersant functions both as a viscosity index improver and as a dispersant. Examples of viscosity index improver dispersants include reaction products of amines, for example polyamines, with a hydrocarbyl-substituted mono- or dicarboxylic acid in which the hydrocarbyl substituent comprises a chain of sufficient length to impart viscosity index improving properties to the compounds. In general, the viscosity index improver dispersant may be, for example, a polymer of a C₄ to C₂₄ unsaturated ester of vinyl alcohol or a C₃ to C₁₀ unsaturated mono-carboxylic acid or a C₄ to C₁₀ di-carboxylic acid with an unsaturated nitrogen-containing monomer having 4 to 20 carbon atoms; a polymer of a C₂ to C₂₀ olefin with an unsaturated C₃ to C₁₀ mono- or di-carboxylic acid neutralised with an amine, hydroxyamine or an alcohol; or a polymer of ethylene with a C₃ to C₂₀ olefin further reacted either by grafting a C₄ to C₂₀ unsaturated nitrogen-containing monomer thereon or by grafting an unsaturated acid onto the polymer backbone and then reacting carboxylic acid groups of the grafted acid with an amine, hydroxy amine or alcohol.

Pour point depressants, otherwise known as lube oil flow improvers (LOFI), lower the minimum temperature at which the fluid will flow or can be poured. Such additives are well known. Typical of those additives that improve the low temperature fluidity of the fluid are C₈ to C₁₈ dialkyl fumarate/vinyl acetate copolymers, and polymethacrylates. Foam control can be provided by an antifoamant of the polysiloxane type, for example, silicone oil or polydimethyl siloxane.

Some of the above-mentioned additives can provide a multiplicity of effects; thus for example, a single additive may act as a dispersant-oxidation inhibitor. This approach is well known and need not be further elaborated herein.

In the present invention it may be necessary to include an additive which maintains the stability of the viscosity of the blend. Thus, although polar group-containing additives achieve a suitably low viscosity in the pre-blending stage it has been observed that some compositions increase in viscosity when stored for prolonged periods. Additives which are effective in controlling this viscosity increase include the long chain hydrocarbons functionalized by reaction with mono- or dicarboxylic acids or anhydrides which are used in the preparation of the ashless dispersants as hereinbefore disclosed.

When lubricating compositions contain one or more of the above-mentioned additives, each additive is typically blended into the base oil in an amount that enables the additive to provide its desired function. Representative effective amounts of such additives, when used in crankcase lubricants, are listed below. All the values listed are stated as mass percent active ingredient.

| ADDITIVE | MASS % (Broad) | MASS % (Preferred) |
|---|---|---|
| Metal Detergents | 0.1-15 | 0.2-9 |
| Corrosion Inhibitor | 0-5 | 0-1.5 |
| Metal Dihydrocarbyl | 0.1-6 | 0.1-4 |
| Dithiophosphate | | |
| Antioxidant | 0-5 | 0.01-2 |
| Pour Point Depressant | 0.01-5 | 0.01-1.5 |
| Antifoaming Agent | 0-5 | 0.001-0.15 |
| Supplemental Antiwear | 0-1.0 | 0-0.5 |
| Agents | | |
| Friction Modifier | 0-5 | 0-1.5 |
| Viscosity Modifier | 0.01-10 | 0.25-3 |
| Basestock | Balance | Balance |

Preferably, the Noack volatility of the fully formulated lubricating oil composition (oil of lubricating viscosity plus all additives) will be no greater than 12, such as no greater than 10, preferably no greater than 8.

It may be desirable, although not essential, to prepare one or more additive concentrates comprising additives (concentrates sometimes being referred to as additive packages) whereby several additives can be added simultaneously to the oil to form the lubricating oil composition.

The final composition may employ from 5 to 25 mass %, preferably 5 to 18 mass %, typically 10 to 15 mass % of the concentrate, the remainder being oil of lubricating viscosity.

This invention will be further understood by reference to the following examples, wherein all parts are parts by weight of total components, unless otherwise noted and which include preferred embodiments of the invention.

### EXAMPLES

### Example 1

Maleated overbased detergents were prepared using the following method:

2500 grams of a detergent (see the list of detergents in the table in Example 2) were charged into a five liter, four necked round bottom flask and heated to 80-85° C. with stirring under a nitrogen blanket. Thereafter, 125 grams of maleic anhydride (5%) were slowly added to the hot solution. The rate of addition of maleic anhydride was controlled by the amount of foaming produced during the reaction. Once the maleic anhydride addition was complete, the reaction mixture was soaked at 80-85° C. for one hour with stirring under a nitrogen blanket. The product was then cooled to room temperature and collected.

### Example 2

Overbased maleated detergents were tested for their compatibility with friction modifiers. All examples were blended so that they had equivalent TBNs. The examples were stored at 60° C. for 12 weeks and they were observed at weekly intervals. The ‘Time to Fail’ shows the number of weeks after which instability was exhibited by evidence of haze and/or sediment.

| | Comp. | | Comp. | | Comp. | |
|---|---|---|---|---|---|---|
| | Example 1 | Example 2 | Example 3 | Example 4 | Example 5 | Example 6 |
| 300 TBN sulphonate detergent | 17.78 | | | | | |
| Maleated 300 TBN sulphonate detergent | | 17.78 | | | | |
| 410 TBN sulphonate/phenate complex detergent | | | 12.60 | | | |
| Maleated 410 TBN sulphonate/phenate complex detergent | | | | 12.60 | | |
| 350 TBN sulphonate/salicylate/phenate complex detergent | | | | | 14.70 | |
| Maleated 350 TBN sulphonate/salicylate/phenate complex detergent | | | | | | 14.70 |
| Dispersant | 35.56 | 35.56 | 35.56 | 35.56 | 35.56 | 35.56 |
| ZDDP anti-wear agent | 7.11 | 7.11 | 7.11 | 7.11 | 7.11 | 7.11 |
| Friction Modifier- ethoxylated tallow amine (‘ET2’) | 1.67 | 1.67 | 1.67 | 1.67 | 1.67 | 1.67 |
| Friction Modifier- glycerol mono-oleate (‘GMO’) | 3.34 | 3.34 | 3.34 | 3.34 | 3.34 | 3.34 |
| Aminic anti-oxidant | 7.78 | 7.78 | 7.78 | 7.78 | 7.78 | 7.78 |
| Phenolic anti-oxidant | 8.89 | 8.89 | 8.89 | 8.89 | 8.89 | 8.89 |
| Anti-foam agent | 0.01 | 0.01 | 0.01 | 0.01 | 0.01 | 0.01 |
| Base oil | 17.86 | 17.86 | 23.04 | 23.04 | 20.94 | 20.94 |
| Time to Fail (in weeks) | 3 | 8 | 1 | More than | 1 | More than |
| | | | | 12 weeks | | 12 weeks |

| | Comparative Example 7 | Example 8 | Example 9 |
|---|---|---|---|
| Polyisobutenyl succinic anhydride | 2.30 | 2.30 | 2.30 |
| Overborated dispersant | 4.13 | 4.13 | 4.13 |
| Thermal dispersant | 48.47 | 48.47 | 48.47 |
| 171 TBN salicylate detergent | 21.93 | | |
| Maleated 171 TBN salicylate detergent | | 21.93 | 21.93 |
| 65 TBN salicylate detergent | 4.23 | 4.23 | 4.23 |
| ZDDP | 7.30 | 7.30 | 7.30 |
| Aminic anti-oxidant | 3.83 | 3.83 | 3.83 |
| Anti-foam | 0.02 | 0.02 | 0.02 |
| Base oil | 4.73 | 4.73 | 4.73 |
| Friction Modifier- glycerol mono-oleate (‘GMO’) | 3.00 | 3.00 | |
| Friction Modifier- tallow acid ester of triethanol amine (‘TEEMA’) | | | 3.00 |
| Time to Fail (in weeks) | 1 | 5 | 8 |

As shown above, improved compatibility of detergents with friction modifiers is achieved by reacting the detergents with a water-soluble α,β-unsaturated carbonyl compound.

In the specific Examples, the amounts given are total components and not active ingredient.

Maleated detergents were also tested for their compatibility with other detergents:

| | Comparative | Example | Comparative | Example |
|---|---|---|---|---|
| | Example 10 | 11 | Example 12 | 13 |
| 300 TBN calcium | 25 | | 25 | |
| sulphonate detergent | | | | |
| Maleated 300 | | 25 | | 25 |
| TBN calcium | | | | |
| sulphonate detergent | | | | |
| 171 TBN calcium | 25 | 25 | | |
| salicylate detergent | | | | |
| Maleated 171 | | | 25 | 25 |
| TBN calcium | | | | |
| salicylate detergent | | | | |
| Base oil | 50 | 50 | 50 | 50 |
| Time to fail | 3 | More than | 2 | More than |
| (in weeks) | | 12 weeks | | 12 weeks |

As shown in the Table above, improved compatibility between a sulphonate detergent and a salicylate detergent is achieved by reacting the sulphonate detergent rather than the salicylate detergent with the water-soluble α,β-unsaturated carbonyl compound (see comparative example 12 and example 13).

What is claimed is:

1. A method of improving the stability of a detergent, or of improving the compatibility of a detergent with another additive in a lubricating oil composition; the method involving the step of reacting the detergent with a water-soluble α,β-unsaturated carbonyl compound.

2. The method claimed in claim 1, wherein the detergent is an overbased oil soluble detergent comprising an alkali- or alkaline earth metal hydrocarbyl phenate, carboxylate, sulphonate, or complex/hybrid detergent of a phenate, carboxylate, salicylate and/or sulphonate.

3. The method claimed in claim 1, wherein the water-soluble α,β-unsaturated carbonyl compound is selected from maleic anhydride, itaconic anhydride, citriconic anhydride, alkyl maleic anhydride, cycloalkyl maleic anhydride, acrylic acid and methacrylic acid.

4. The method claimed in claim 3, wherein the water-soluble α,β-unsaturated carbonyl compound is maleic anhydride.

5. The method claimed in claim 1, wherein said detergent is reacted with from about 0.5 to about 10 wt. % of water-soluble α,β-unsaturated carbonyl compound, based on the weight of detergent.

6. The method claimed in claim 5, wherein said detergent is reacted with from about 1 to about 5 wt. %, of water-soluble α,β-unsaturated carbonyl compound, based on the weight of detergent.

7. The method claimed in claim 2, wherein said alkaline earth metal is selected from calcium and magnesium.

8. The method as claimed in claim 1, wherein the method improves the compatibility of a sulphonate detergent with a salicylate detergent and comprises reacting the sulphonate detergent with the water-soluble α,β-unsaturated carbonyl compound.

9. The method as claimed in claim 1, wherein the method improves the compatibility of the detergent with a friction modifier.

10. The method as claimed in claim 9, wherein the friction modifier is selected from: glycerol monoesters; esters of long chain polycarboxylic acids with diols; oxazoline compounds; alkoxylated alkyl-substituted mono-amines, diamines and alkyl ether amines; and molybdenum compounds.
